(19) United States
(12) Patent Application Publication
(10) Pub. No.: US 2004/0120847 A1
(43) Pub. Date: Jun. 24, 2004

(54) Reducing the corrosivity of water-containing oil-mixtures

(76) Inventor: Willem Dijkhuizen, Zuidlaren (NL)

Correspondence Address: SWANSON & BRATSCHUN L.L.C., 1745 SHEA CENTER DRIVE, SUITE 330, HIGHLANDS RANCH, CO, 80129, US

(21) Appl. No.: 10/328,929

(22) Filed: Dec. 24, 2002

(51) Int. Cl. C23F 11/04; C04B 9/02; B32B 5/02

(52) U.S. Cl. 422/7; 422/12; 106/14.05; 106/14.34

(57) ABSTRACT

For decreasing the corrosivity of a water-containing corrosive crude oil mixture, a composition capable of dispersing water in the crude oil is included in the crude oil mixture, such that in use the amount of water at a surface between the crude oil and a corrosion-sensitive material is decreased. Compositions to be used for decreasing the corrosivity of a water-containing corrosive crude oil mixture and applications of the proposed anti-corrosion measures are also described.

### FIELD OF THE INVENTION

The present invention relates to corrosion prevention. More specifically, the invention relates to a method for decreasing the corrosivity of a water-containing crude oil mixture and to a composition for use in a method for inhibiting corrosion of a metal that is used for the transport or storage of a corrosive Water-containing crude oil mixture, such as a steel pipeline.

### BACKGROUND OF THE INVENTION

Generally speaking, corrosion refers to atmospheric oxidation of metals. Millions of dollars are lost each year in the petroleum and crude oil industry because of corrosion damage to, inter alia, steel pipelines. In the U.S., corrosion-related cost to the transmission pipeline industry is approximately $5.4 to $8.6 billion annually. Most crude oils or crude petroleum contain a certain amount of water. Therefore, whole crude oils are often corrosive to metal equipment used to extract, transport and process the crude oil, such as pipelines, pumps and reaction vessels. The concentration of water molecules in a crude oil is often relatively low, typically ranging from 500-1000 ppm. However, the presence of salt in a crude oil mixture containing seawater greatly enhances the corrosivity of such a mixture. This is primarily due to the fact that the dissolved salt increases the conductivity of the aqueous solution formed at the surface of the metal and enhances the rate of electrochemical corrosion. An important form of corrosion is the rusting of iron. Rusting is essentially a process of oxidation in which iron combines with water and oxygen to form rust, the reddish-brown crust that forms on the surface of the iron. The problem with iron as well as many other metals is that the oxide formed by oxidation does not firmly adhere to the surface of the metal and flakes off easily causing “pitting”. Extensive pitting eventually causes structural weakness and disintegration of the metal. In addition to the economical damage, corrosion of pipelines transporting hazardous liquids may result in liquid spilling into the environment which can cause severe ecological and environmental damage.

The direct costs associated with the corrosion of a valve, an oil tanker, a gas pipeline, can be tremendously amplified when the subsequent events result in environmental pollution. Releases of oil from pipelines can contaminate drinking water and crops, cause expensive property-damage,-kill fish, and create explosions and fires.

In the past few years, a number of high-profile pipeline failures (both liquid and natural gas) have refocused concern on pipeline safety. Public safety concerns have provided the driving force for new regulations governing pipeline operations. The most significant of these, from a cost point of view, is the requirement for pipeline inspections. In-line inspection (i.e., “smart pigging”) is the one most often discussed. This technique is often used to find corrosion flaws larger than a certain size (typically 10 percent of pipe wall thickness). Whereas in-line inspection can be valuable for locating flaws before they become critical and cause pipeline failure (either leaks or rupture), a preferred approach would obviously involve a method to prevent the onset and/or progress of corrosion.

Corrosion can be defined as the unwanted production of a salt from a metal. The main ways of slowing corrosion down (inhibition) are by providing an impermeable coating to stop the chemical reaction from occurring in the first place, or by providing a more easily attacked metal which will be consumed first (a ‘sacrificial anode’). Efforts to prevent pipeline corrosion have included a number of approaches, most of which concern external corrosion protection. Buried pipelines usually receive two forms of external corrosion protection: the external coating on the pipeline and the cathodic protection (CP). The primary purpose of the coating is to protect the pipe surface from its external environment. Over the years, pipelines have been protected by various polymeric coatings. In the 1950s and 1960s, coal tar or asphalt coatings were applied. In the mid-1950s, mill-applied extruded polyethylene coatings were introduced (primarily on small-diameter pipes). From the early 1960s to the early 1980s, polyethylene tape coatings were field applied. To date, many pipelines are coated using the liquid epoxy systems well known to the industry (SP-3888, EC-376, Densopol 7000, etc.). Many existing pipelines are experiencing external corrosion due to deterioration of the coating system applied at time of construction. Some pipelines deteriorate slowly, and in certain cases pipeline life has been reliably targeted at 70 years or more. Other pipelines have been built which have exhausted their useful life after 1 year of operation. Cathodic protection can to a certain extent protect the external pipeline surface against corrosion at coating defects that are invariably present. A major disadvantage of external coating lies in the fact that the coating condition tends to deteriorate with time, leading to increased CP current requirements. Apart from the quality of the construction, coatings, CP systems etc, the factors which affect pipeline life include nature of the product, nature of the external environment, operating conditions and quality of maintenance.

In contrast with external corrosion on a pipe, which is visible when the pipe is exposed, internal corrosion is not readily apparent. For corrosion to occur there must be liquid water present. One approach is to eliminate or reduce water entry into the system. Possible courses of action to remove water before it enters the system include separation equipment such as dryers, desorbers and dehydrators. In a desorber the oil is heated before it meets a counter flow of cool air in the desorber housing. The air is heated by the oil, expands and draws steaming water from the oil. A subsequent air-cooling condenses the water which can then be drained. A desorber can dry the oil down to a water content of <200 ppm removing 4-6 L of water per hour. Desorbers can for example be used for removing water from lubricating and hydraulic oils, both mineral and synthetic. However, desorbers are generally not suitable for large scale applications and are therefore not of use for the crude oil industry.

Chemical inhibition is an other option that can be used to control internal corrosion. Generally speaking, a corrosion inhibitor is defined as a substance that depends on either chemically adsorbed film, or by forming a complex with the metal surface, to control corrosion. Once applied to the internal surface, the film forms a highly adherent bond with metal surfaces and self-heals minor nicks and scratches. Coating life-time is limited as the layer wears out as a result of constant friction and abrasion, for instance by particles like sand entrained with the oil. When installing a new pipe in a pipeline system, pipes are usually welded together. Whereas new pipes are easily provided with a protective internal coating, the area at around the welds or seals cannot. Thus, an internal coating is in general not capable of protecting a region at or near welds, valves or fittings against corrosion. Furthermore, the inhibitor's ability to form an impervious long-lasting film strongly depends on its chemical structure and the location in which it is placed. Coating layers often consist of only a single molecular layer of a coating chemical and are therefore susceptible to wearing out. In addition, pipelines are in general not fully horizontally positioned. In fact, many pipeline systems traverse hilly or mountainous country. Lower areas of a pipeline system can easily become water traps, causing deterioration of internal coatings and accelerating corrosion problems internally. Thus, it is essentially unfeasible to provide an object, such as a pipeline interior, with a continuous and everlasting layer of protective coating. Corrosion inhibitors also relate to those chemical agents that alter the environment to make it less corrosive or remove the corrosive agent. For example, U.S. Pat. No. 3,996,058 discloses that chromate salts can be used to inhibit the effects of corrosive attack on the inner wall of pipelines used to transport coal slunies. The chromium ion can consume or scavenge dissolved oxygen, being the principal agent of corrosion in a coal slurry. U.S. Pat. No. 5,556,451 refers to hydroxybenzoic acid-containing compositions and methods using the same to inhibit oxygen-induced corrosion of metals exposed to aqueous solutions. U.S. Pat. No. 6,022,494 reports the use of a Group IA and IIA metal-containing compound to neutralize organic acids in crude oils that contribute to corrosion.

### SUMMARY OF THE INVENTION

A method is provided for decreasing the corrosivity of a water-containing corrosive crude oil mixture, comprising providing said crude oil with an effective amount of a composition capable of dispersing water throughout said oil by absorbing or encapsulating water, such that in use the amount of water at a surface between said crude oil and a corrosion-sensitive material is decreased. The present invention may suitably comprise, consist or consist essentially of the elements disclosed and may be practiced in the absence or presence of an element not disclosed.

### DETAILED DESCRIPTION OF THE INVENTION

It is generally known that corrosion or rusting of a metal requires the presence of oxygen and water molecules. The invention provides the insight that a water-absorbing composition can be added to a water-containing corrosive liquid, such as a crude oil mixture, to disperse small amounts of water throughout the oil. Herewith, the corrosivity of such a corrosive liquid is reduced because water is essentially excluded from a corrosion-sensitive surface. The term corrosivity refers to the degree or extent by which a substance can cause corrosion of a metal surface when in contact with said surface. A substance with a high corrosivity is a substance having a high tendency to cause corrosion. Crude oil and natural gas are extracted from the ground, on land or under the oceans, by sinking an oil well and are then transported by pipeline and/or ship to refineries where their components are processed into refined products. Crude oil and natural gas are of little use in their raw state; their value lies in what is created from them: fuels, lubricating oils, waxes, asphalt, petrochemicals and pipeline quality natural gas.

Provided is a method for decreasing the corrosivity of a water-containing corrosive crude oil mixture, comprising providing said crude oil with an effective amount of a composition capable of dispersing water in said crude oil, such that in use the amount of water at the interface, surface or contact area between said crude oil and a corrosion-sensitive material is decreased. Addition of a composition provided to a water-containing crude oil mixture, typically results in a colloid or an emulsion. Colloids are regarded as systems in which there are two or more phases, with one (the dispersed phase) distributed in the other (the continuous phase). Colloids can be classified in various ways. Emulsions are colloidal systems in which the dispersed and continuous phases are both liquids, e.g. oil-in-water or water-in-oil. In a preferred embodiment, a water-containing crude oil is contacted with a composition capable of forming an emulsion wherein water is dispersed in the continuous oil phase. Since it is foremost the continuous phase, rather than the dispersed phase, which is in direct contact with a corrosion-sensitive surface, said composition provided is instrumental in reducing or minimizing corrosion of a metal in contact with a corrosive crude oil. In a preferred embodiment, said composition is capable of absorbing or encapsulating water molecules. An emulsion is a mixture of two components which normally do not mix, such as oil and water, in which one component is distributed, e.g. as droplets, in the other. The droplet component is known as the ‘dispersed’ phase and the other as the ‘continuous’ phase.

Provided is a method for reducing corrosion of a corrosion-sensitive surface or material which is in contact with a water-containing crude oil mixture. In general, a corrosion-sensitive material comprises a metal. Such a corrosion-sensitive material for example comprises an object or device that is used to transport a crude oil mixture or another water-containing corrosive liquid. For example, it is a steel pipeline, an oil tanker or any other type of corrosion-sensitive object that is suitable for transporting a water-containing corrosive liquid. Also provided is a method for reducing corrosion of a corrosion-sensitive material that is used for the storage of a water-containing corrosive liquid like for example a crude oil mixture such as a storage vessel, an oil tanker, an oil barrel, an oil plunger pump, an oil drum, a reservoir, and the like.

In a preferred embodiment, a crude oil mixture is provided with a composition comprising at least a hydrophilic or a hydratable compound. Hydrophilic compounds are commonly defined as water-attracting or water-loving compounds. A hydrophilic compound or molecule has a strong affinity for water and tends to be wetted by water. The term hydratable refers to a compound that can form a hydrate in the presence of water. A hydrate is a compound that is chemically bonded to water. Polar molecules represent one group of hydrophilic molecules. Polar molecules have dipoles. A dipole is a partial electrical charge on a portion of a molecule that is due to the unequal sharing of electrons by the atoms of the molecule. Because of the dipoles, when one mixes polar molecules together, the negative dipole of one molecule and the positive dipole of another will be weakly attracted to one another. This weak attraction is called a hydrogen bond and the formation of this bond allows for polar molecules to dissolve in one another. Since a water molecule is a polar molecule, a composition according to the invention for decreasing or inhibiting corrosion advantageously comprises a polar or a hydrophilic compound. A polar or a hydrophilic compound has a relatively high affinity for water and is thus capable of absorbing water present in a corrosive crude oil mixture. Absorbed water molecules are thereby essentially excluded from a corrosion-sensitive surface and can no longer take part in a chemical reaction associated with corrosion.

Thus, it will be clear that a composition that is suitable for practicing the present invention can comprise a large variety of chemicals, substances, molecules, natural compounds, and mixtures thereof. Many different classes of compounds can be used, as long as they are capable of minimizing, or even fully preventing, the presence of water molecules at a metal surface in contact with a water-containing crude oil mixture. This is usually achieved by their capacity to chemically and/or physical trap, absorb, accommodate or enclose water molecules such that water becomes dispersed in a crude oil.

To pump oil, it is often heated so as to lower the viscosity and to make pumping to through a pipeline easier. The temperature of a crude oil during transport, e.g. oil in a pipeline system, can increase up to 80 to 90 degrees Celsius. Therefore, a composition according to the invention is preferably capable of forming a heat-stable dispersion of water in a crude oil. Advantageously, using a composition or dispersant according to the invention, water remains dispersed throughout the homogenous oil phase at a high temperature, such as up to 80 or 90 degrees Celsius or even 100 degrees Celsius.

In one embodiment, a composition according to the invention for inhibiting corrosion comprises a polymer. A polymer can be a synthetic or man-made polymer. A suitable polymer can be a homopolymer or a copolymer. A homopolymer is made by linking only one type of small molecule, or monomer, together. When two different types of monomers are joined in the same polymer chain, the polymer is called a copolymer. A polymeric compound, or polymer, according to the invention can preferably absorb or attract water. In a process of absorption, one substance is taken up into the interior of another. For example, a suitable polymer comprises a superabsorbent polymer. Superabsorbent polymers can absorb huge amounts of aqueous liquids even under fairly high pressure. These materials can take up to 25 times their own weight of physiological saline solution even when a weight of 49.2 g/cm² (0.7 psi) is applied. Provided herein is a composition comprising a polyacrylate or a derivative thereof, which contain acrylic monomers as building blocks. An acrylate polymer is a linear, anionic polymer made from the monomer acrylic acid, CH2═CHCOO—H+. The acrylic acid groups are evenly spaced along the chain. Acrylic acid polymer neutralized with NaOH is sodium polyacrylate (SPA). Polyacrylic acid can absorb many times its own weight in water with no problem. Polymers that do this are called superabsorbers. Water molecules orient themselves around the negatively charged carboxylate groups of the sodium polyacrylate. The water is drawn into the matrix of the polymer chains, forming a gel which can swell to several hundred times its original size. Superabsorbent Polyacrylates are widely applied in baby diapers, incontinence bags and sanitary towels. In one embodiment of the invention, a composition is provided comprising at least a superabsorbent polymer. For example, a composition according to the invention comprises a fully, or a partially neutralized polyacrylate or a derivative thereof. This polyacrylate is advantageously cross-linked to increase its water absorbing capacity. Of particular interest for practicing a method according to the invention is the superabsorbent material known under the brandname PolySorb which is produced by BASF. HySorb can be delivered in different ways: in 20 kg moisture-proof bags and in “Big Bags”/“Super Sacks” of different sizes. Polyacrylamide is a non toxic biodegradable product. Super absorbent polyacrylamide polymers simply break down to CO₂, water and nitrogen.

A derivative is a compound that can be imagined to arise from a parent compound by replacement of one atom with another atom or group of atoms. A derivative is derived or obtained from another and generally contains one or more essential elements of the parent substance. Several derivatives of polyacrylates contain nitrogen, such as polyacrylamide. Polyacrylamide will dissolve in water and is used industrially. Crosslinked polyacrylamides can absorb water. Crosslinked materials can't dissolve in solvents, because all the polymer chains are covalently tied together. A piece of a crosslinked material that has absorbed a lot of solvent is called a gel or a hydrogel. Thus, in one embodiment of the invention, a composition at least comprising a crosslinked polymer, such as crosslinked polyacrylamide, is added to a water-containing crude oil mixture used to reduce the corrosivity of such a crude oil mixture. In a preferred embodiment, a method is provided for decreasing the corrosivity of a water-containing corrosive crude oil mixture, comprising providing said crude oil with an effective amount of a composition capable of dispersing water in said crude oil by absorbing or encapsulating water, wherein said composition comprises a polymer capable of forming a gel or a hydrogel. Preferably, the degree of cross-linking of a polymer is such that it allows a maximal absorption and/or immobilization of water molecules. When used as an oil additive, a polymer according to the invention is capable of dispersing water in a crude oil by absorbing water into its matrix or three dimensional network.

Super absorbent polyacrylamide polymers are marketed under a variety of brand names such as Expanding Crystals, HySorb, Watergems, Water Diamonds, Soilmoist, Aquasorb, California Crystals, Water Crystals, Watersorb, Terrasorb, Hydrosource, Hydro-Mulch, Moist Soil, Agrosoke, Smart Soil, Aqua Crystal, Agrodiamonds, Gel Crystal, Crystal Ice, Stamoist, Cracked Ice, Floragel, Floramoist, Dehydrated Florist Gel. HySorb is particularly interesting for use in a method according to the invention. HySorb is currently used for, among others, the external protection of underground electric and telecommunication cables. If there is a small crack in the plastic of a cable, minimal amounts of water leaking in cause HySorb to swell. This closes the crack on the one hand and on the other blocks the pores to prevent further diffusion of the water.

In a further embodiment, an anti-corrosive composition, or corrosion inhibitor, comprises a polyurethane or a derivative thereof. Polyurethane is a polymerisation product of a polyol and a polyisocyanate. A polyol is a generic name for low molecular weight, water-soluble polymers and oligomers containing a large number of hydroxyl groups. Examples include glycols, polyglycols and polyglycerols. Polyurethane products such as prepolymers or foam have a hydrophilic character and can absorb fluids, including water, up to 20 times their own weight. Of special interest is a high performance hydrophilic polyurethane grout that is marketed under the brand name RESINEX. This polyurethane typically reacts with water up to ten times its own volume.

In addition to synthetic polymers, an anti-corrosive composition according to the invention may comprise a naturally occurring polymer. For example, provided are carbohydrate polymers or derivatives thereof which are added to a corrosive crude oil to absorb the water that it present in a crude oil, thereby reducing the amount of water at a surface between a crude oil and a corrosion-sensitive material. A carbohydrate contains only the elements carbon, hydrogen, and oxygen. Carbohydrates as a class are naturally hydrophilic due to their abundant hydroxyl groups. Cellulose, starch, sugars and polyols all are examples. In one embodiment of the invention, a composition comprising cellulose or a functional derivative thereof is added to a water-containing crude oil mixture to reduce its corrosivity. Cellulose is a carbohydrate, and the molecule is a long chain of glucose (sugar) molecules with OH groups on the outer edge. These negatively charged groups attract water molecules and make cellulose and cotton absorb water well. Cotton is pure cellulose and can absorb about 25 times its weight in water.

In another embodiment, a method for reducing the corrosivity of a whole crude oil or a crude petroleum that contains water comprises adding starch or a derivative thereof to the oil or petroleum to absorb and disperse water, such that it is no longer available for the oxidation of metal, e.g. via the formation of hydroxide ions. Starch is a carbohydrate polymer occurring in granular form certain plant species notably cereals, tubers, and pulses such as corn, wheat, rice, tapioca, potato, pea etc. The polymer consists of linked anhydro-a-D-glucose units. It may have either a mainly linear structure (amylose) or a branched structure (amylopectin). A starch derivative refers to a product produced from native starch including modified starches and starch hydrolysis products. For example, a starch or starch derivative, such as a starch ester or ether, can be used that originates from corn, potato, tapioca or sago. A starch ester is a chemically modified starch in which some of the hydroxyl groups have been replaced by ester groups. Acetylation with acetic anhydride is an example of starch esterification. A starch ether is a chemically modified starch in which some of the hydroxyl groups have been replaced by ether groups. Hydroxyethylation with ethylene oxide is an example of starch etherification.

Provided is a composition for use in a method according to the invention comprising chemically modified starch, for example a starch derivative containing a synthetic material. A product sold under the brandname Superslurper is a cornstarch derivative that can hold hundreds of times its own weight in water; it is used in products as disposable diapers, kitty litter, and soil pellets that retain water for farms and gardens.

In yet another embodiment, a composition includes hydratable clay minerals. The term clay refers to a large family of complex minerals containing the elements magnesium, aluminum, silicon and oxygen (magnesium, aluminum silicates) combined in a sheet-like structure. Suitable clay minerals for practicing a method according to the invention include montmorillonite and bentonite. Montmorillonite is a hydratable, dispersible clay mineral of the smectite group that tends to swell when exposed to water. Montmorillonite is a three-layer, expanding clay with a large surface area and high cation-exchange capacity. Na⁺ and Ca²⁺ are the typical exchangeable cations. Sodium montmorillonite is also called sodium bentonite. Montmorillonite forms through the alteration of silicate minerals in alkaline conditions in basic igneous rocks, such as volcanic ash that can accumulate in the oceans. Natural deposits are found in Wyoming, North Dakota, South Dakota and Utah, USA. Calcium montmorillonite is a low-yield bentonite that is more widely distributed than sodium montmorillonite and is used in many commercial applications, including drilling mud. Other suitable compositions according to the invention comprise zeolite. Physical and chemical characteristics of Zeolite result from its aluminosilicate skeleton structure allowing for dehydration, ion exchange and various size molecule absorption without affecting them.

In a further embodiment of the invention, a composition at least comprising an amphipathic compound capable of enclosing water is provided. An amphipathic compound or molecule contains a nonpolar, lipophilic group (the ‘tail’) which has an antipathy to water (or other strongly polar liquid) and also a hydrophilic or polar ‘head’ group which has an antipathy to nonpolar oils. Examples of an amphipathic compound are an emulsifier or a surfactant. Provided is a method for providing a corrosive water-containing crude oil mixture with a suitable emulsifier, or a surfactant, that allows the formation of a water-in-oil emulsion. In such an emulsion, water molecules are surrounded, enclosed or trapped by an emulsifier or surfactant to form a micelle or a related structure. This results in a reduced amount of “free” water molecules that are available for causing corrosion. A micelle is an aggregate of molecules in a colloid. Colloids are regarded as systems in which there are two or more phases, with one (the dispersed phase) distributed in the other (the continuous phase). Colloids are classified in various ways. Emulsions are colloidal systems in which the dispersed and continuous phases are both liquids, e.g. oil-in-water or water-in-oil. Such systems require an emulsifying agent to stabilize the dispersed particles. Provided herein is a method for dispersing water in oil, wherein said dispersed water molecules are enclosed or encapsulated by a composition according to the invention. Because oil represents the homogenous or continuous phase in such a colloid, water is excluded from the contact area or contact surface. Corrosion of a steel or metal surface in contact with a water-containing crude oil can thus be reduced using a composition according to the invention. A complex or unit comprising a composition according to the invention which has absorbed or enclosed a certain amount of water molecules can be transported, for example together with the crude oil mixture. A unit or a complex may comprise a micelle, for instance in a W/O emulsion, or it may comprise a polymer particle or granule which has absorbed water in its 3-dimensional network structure. A method according to the present invention is advantageously practiced through emulsification of water molecules in a crude oil by using an oil-soluble surfactant to form a stable water-in-oil emulsion. A surfactant is a chemical that acts as a surface active agent. This term encompasses a multitude of materials that function as emulsifiers, dispersants, oil-wetters, water-wetters, foamers and defoamers. The type of surfactant behavior, whether acting as an emulsifier or dispersant or otherwise, depends on the structural groups on the molecule (or mixture of molecules). It is obviously preferred that in a method according to the invention a water-in-oil (W/O) emulsifier is used. W/O emulsions are often heat stable up to 100 degrees Celsius or more, which is obviously advantageous in a method according to the invention because of the elevated temperature of an oil that may occur during transport. Most, if not all emulsifiers consist of a molecule that combines both hydrophilic and lipophilic groups. The Hydrophile-lipophile balance (HLB) number of an emulsifier or a surfactant is an expression of the balance of the size and strength of the hydrophilic (water-loving or polar) and the lipophilic (oil-loving or non-polar) groups of the emulsifier. The HLB is related to its solubility. An emulsifier having a HLB below 9 will tend to be oil-soluble. An emulsifier having a HLB above 9 will tend to be water-soluble. Thus, in a preferred embodiment of the invention, a lipophilic surfactant or emulsifier is used i.e. wherein the HLB is below 9. It is even more preferred that a surfactant or emulsifier is used wherein HLB is in the range of 3-7. Most suitably, the invention is practiced using an emulsifier with an HLB of approximately 5. Since a crude oil may contain salt e.g. from seawater, a composition according to the invention can tolerate a high level of inorganic salts or water miscible organic materials in the aqueous phase. Importantly, suitable compositions also comprise those containing blends of emulsifiers or surfactants. Blends usually give more stable emulsions than any single emulsifier, even though the single emulsifier might have the desired HLB. The most stable emulsion systems usually consist of blends of two or more emulsifiers, one portion having lipophilic tendencies, the other hydrophilic. Crude oil generally refers to thick flammable mineral oil found underground in permeable rocks. Crude oil is a general term for unrefined petroleum or liquid petroleum. Petroleum is a complex mixture of naturally occurring hydrocarbon compounds found in rock. Petroleum can range from solid to gas, but is generally used as a synonym for liquid crude oil. Impurities such as sulfur, oxygen and nitrogen are common in petroleum. There is considerable variation in color, gravity, odor, sulfur content and viscosity in petroleum from different areas. Thus, a crude oil mixture may contain different types of oil. In a preferred embodiment of the invention, a certain crude oil mixture is provided with a composition, e.g. comprising a single emulsifier or an emulsifier blend, that is tailor-made. In other words, a composition according to the invention is preferably especially suitable for use as corrosion-inhibitor for that type of crude oil mixture under certain conditions. This is easily achieved by subjecting a test sample of a crude oil to a systematic analysis of the degree of emulsification using many different types of emulsifiers. Instrumentation and experimental set-up to perform such an analysis are routinely available for a person skilled in the art.

In one embodiment, an emulsifier according to the invention comprises a polymeric surfactant. Nowadays polymeric surfactants are increasingly being used in many technological applications where stability is needed at high disperse phase volume fraction and high electrolyte concentrations, as well as under extreme conditions of temperature and flow. Whereas especially suitable polymeric surfactants include those compounds generally known under the brandname HYPEPMER, such as HYPERMER A60, B246, 2234, B261, 2296, and the like, other polymeric surfactants may be used as well. For example, a compound that is marketed under the brand name Atlox4912 is also instrumental in practicing a method according to the invention. Other emulsifiers of use for the invention are those selected from the group consisting of mono-or diglycerides, sorbitan fatty acid esters, polyoxyethylene sorbitol esters and polyoxyethylene alcohols.

It should be emphasized that a composition provided herein is not limited to contain one type of compound capable of absorbing or encapsulating water. In contrast, a composition according to the invention can also comprise a mixture of any of the compounds or chemicals mentioned above. For instance, a superabsorbent polymer may be combined or chemically linked to a hydratable clay mineral. Superabsorbent hydrogels based on poly(acrylamide)—bentonite composite materials are particularly interesting because of their viscoelastic behaviour and high absorption capacity for water. They also possess interesting theological properties since they are mechanically remarkably stable under shear load and oscillating deformation because of long-range interaction similar to a gel network.

In another embodiment, a W/O emulsifier is mixed with a material having characteristics of Superslurper or the like. The ability of such a mixture to reduce the corrosivity of a water-containing crude oil is exemplified in the detailed description. The invention also provides a composition for use in a method according to the invention. In addition, a crude oil mixture comprising a composition capable of absorbing or encapsulating water is provided. Use of a compound capable of absorbing water is provided for decreasing the corrosivity of a water-containing corrosive crude oil to produce a treated crude oil.

A carbon steel pipeline system including at least one pipeline, and other objects used to store or transport crude oil mixtures, comprising a crude oil mixture provided with a composition according to the invention are also provided. In another embodiment, the invention provides a method for transporting and/or storing a treated crude oil having a reduced corrosivity as a result of using a composition according to the invention. Provided herein is a method for transporting and/or storing a crude oil mixture according to the invention, including the steps of adding a composition according to the invention to a crude oil mixture, and supplying said crude oil mixture to transport means and/or storage means having an oil contacting surface which at least partly is a surface of a corrosion sensitive material.

Also provided is a method for inhibiting corrosion of a metal in contact with a corrosive water-containing crude oil mixture, comprising contacting a crude oil mixture with a composition according to the invention. Also provided is a method for providing a crude oil with a composition according to the invention. Several methods can be used for providing a crude oil with a composition according to the invention. In one embodiment, a certain volume of crude oil is contacted with a certain amount of a suitable composition to prepare a concentrated preparation, or concentrate, which can subsequently be added to a corrosive liquid. For example, a water-containing crude oil is provided at the beginning of a pipeline system with an emulsifier concentrate. Typically, the flow rate of oil in a pipeline is sufficient to ensure rapid mixing of the concentrate and the oil. However, it can sometimes be advantageous to use mechanical mixing. In an other embodiment, a corrosive oil mixture is provide with a composition according to the invention by means of a spiral or helical chute conveyor. Materials can move through such a chute at a constant velocity, typically due to computer aided design. Use of a chute conveyor is especially useful for adding a composition according to the invention comprising a compound in a granular form, for instance a granular polymer, to a crude oil in a controlled manner.

In a method provided, a crude oil mixture is contacted with a composition according to the invention in an amount effective for the purpose of corrosion inhibition. The amount that is effective for the purpose of corrosion inhibition naturally depends on the water content of a corrosive liquid and on the water-absorbing capacity of the composition. Typically, a composition according to the invention comprises only 2 percent by weight of a compound capable of absorbing or encapsulating water relative to the amount of water present in the corrosive liquid to be treated. For example, 1000 tons of crude oil with a water content of 600 ppm contains 600 kilograms of water. Thus, for the purpose of reducing the corrosivity it is preferred to add a composition which contains approximately 12 kg of a water-absorbing compound. This can be achieved by adding a single compound but it is also possible to add a mixture of chemical compounds to absorb or encapsulate water. Depending on the compound characteristics, a higher or a lower amount may also be used. Provided herein is a corrosion inhibitor that, when added to a corrosive environment in relatively small concentrations, effectively reduces the corrosion rate of the metal exposed to that environment.

As said, current approaches to minimize internal corrosion primarily involve internal coating of those metal surfaces in direct contact with a crude oil to increase the corrosion resistance of such a surface. These surfaces, foremost pipeline interiors but also oil tankers, storage vessels and the like, all have to be provided with a coating layer. Usually, the life-time of such a coating is limited. It is therefore particularly advantageous that the rationale of a method provided herein is to solve the corrosion problem at its essence; i.e. by reducing the corrosivity of a crude oil rather than increasing the corrosion resistance of all surfaces in contact with the oil. Following the addition of a composition according to the invention to a water-containing crude oil, the composition preferably remains associated with the crude oil during transport and storage to continuously protect a corrosion-sensitive surface in contact with a crude oil against corrosion. A crude oil can be provided with a composition according to the invention at essentially every stage of the process from its extraction to its refinery. However, to take full advantage of a method provided, it is of course preferred to provide a crude oil with a composition capable of dispersing water throughout the oil at an early stage. A composition according to the invention may for instance be added to a crude oil when it is brought in from an oilfield before it enters a pipeline system to be sent to a refinery or before the oil is boarded onto a tanker.

After it has served its purpose, e.g. after transport of a corrosive crude oil mixture from the site of its extraction to an oil refinery, it may be desired to remove a composition according to the invention from a crude oil mixture. Suitable methods provided herein to remove a solid compound capable of absorbing or encapsulating water from a crude oil mixture include gravity settling or sedimentation. If the dispersed water phase is more dense than the continuous oil phase, the disperse phase particles will migrate downwards and tend to settle at the bottom. For example, a composition according to the invention can be sedimented from a crude oil mixture in shallow pits or by applying hydrocyclone, centrifuge or filtration techniques. Thus, a method for removing a composition from a crude oil mixture is provided, said method including gravitating or sedimenting a composition according to the present invention from said crude oil mixture. A composition comprising a surfactant or emulsifier can be removed by heating or by adding a de-emulsifier.

As mentioned above, it should be emphasized that only a small quantity (around 2% w/w if the water content is 600 ppm, corresponding to 12 ppm) of a water absorbing corrosion-inhibiting compound needs to be added to a crude oil mixture to be effective. Thus, a treated crude oil with reduced corrosivity contains only very little foreign material and special or additional steps for removing a composition according to the present invention may not be necessary. Moreover, a treated crude oil will usually be processed into different products in an oil refinery. As crude oil comes from the well it contains a mixture of hydrocarbon compounds and relatively small quantities of other materials such as oxygen, nitrogen, sulphur, salt and water. An oil refinery is an organized and coordinated arrangement of manufacturing processes designed to produce physical and chemical changes in crude oil to convert it into everyday products like petrol, diesel, lubricating oil, fuel oil and bitumen. In the refinery, most of these non-hydrocarbon substances are removed and the oil is broken down into its various components, and blended into useful products. The various components of crude oil have different sizes, weights and boiling temperatures; so, the first step is to separate these components. Because they have different boiling temperatures, they can be separated easily by a process called fractional distillation. The fractions are further treated to convert them into mixtures of more useful saleable products by various methods such as cracking, reforming, alkylation, polymerisation and isomerisation. These mixtures of new compounds are then separated using methods such as fractionation and solvent extraction. Especially after the extensive process of refinery, it is unlikely that the obtained end-products of a treated crude oil will contain a significant amount of impurities originating from an anti-corrosive additive according to the invention.

### EXAMPLE 1

In order to demonstrate the effectiveness of the invention, tests were performed in which a crude oil containing approximately 600 ppm of water was provided with 2% by weight (12 milligram per kilogram of crude oil) of a W/O emulsifier. A water-in-oil emulsion was obtained by stirring. A plate of carbon steel was polished clean by sandblasting according to Swedish SA guidelines (Svensk Standard Sis 05 59 00). The clean plate was immersed in the water-in-oil emulsion at room temperature for a time interval ranging from 2 to 3 weeks. After different time intervals, rust formation was inspected visually. The plate immersed in the W/O emulsion did not show any clear visible signs of rust up to 3 weeks, whereas a similar carbon steel plate that was immersed in parallel in untreated crude oil showed clear signs of corrosion as evidenced by rust spots at the surface.

### EXAMPLE 2

A test set-up similar to the one described above was used to demonstrate the effectiveness of a superabsorbent polymer to reduced the corrosivity of a water-containing (600 ppm) crude oil mixture. In this case, the crude oil was mixed with 2% (by weight) of partially neutralized polyacrylate granules known under the name HySorb (BASF). Steel plates immersed in crude oil provided with HySorb appeared corrosion resistant. An additional test was performed in which a crude oil was provided with a composition comprising a 1:1 mixture of a W/O emulsifier and HySorb granules (1% by weight each). As expected, this mixture was also capable of dramatically reducing rust formation on a carbon steel plate immersed in a crude oil provided with the mixture.

What is claimed is:

1. A method for decreasing the corrosivity of a water-containing corrosive crude oil mixture, comprising providing said crude oil with an effective amount of a composition capable of dispersing water in said crude oil, such that in use the amount of water at a surface between said crude oil and a corrosion-sensitive material is decreased.

2. A method according to claim 1, wherein said composition is capable of dispersing water in said crude oil by absorbing or encapsulating water.

3. A method according to claim 1, wherein said composition comprises at least a hydrophilic or a hydratable compound.

4. A method according to claim 3 wherein said compound is a polymer.

5. A method according to claim 4 wherein said polymer is a synthetic polymer.

6. A method according to claim 4 wherein said polymer is a superabsorbent polymer.

7. A method according to claim 4 wherein said polymer is a polyacrylate or a derivative thereof.

8. A method according to claim 3 wherein said polymer is a polyacrylamide or a derivative thereof.

9. A method according to claim 3 wherein said polymer is a polyurethane or a derivative thereof.

10. A method according to claim 3 wherein said polymer is a naturally occurring polymer.

11. A method according to claim 3 wherein said polymer is a carbohydrate polymer or a derivative thereof.

12. A method according to claim 11 wherein said carbohydrate polymer is starch or a derivative thereof.

13. A method according to claim 12 wherein said starch is derived from corn, potato, tapioca, sago.

14. A method according to claim 11 wherein said carbohydrate polymer is cellulose or a derivative thereof.

15. A method according to claim 3 wherein said compound includes clay minerals.

16. A method according to claim 1, wherein said composition comprises at least an emulsifier.

17. A method according to claim 16, wherein said emulsifier is an oil-soluble emulsifier.

18. A method according to claim 16, wherein said emulsifier is a water-in-oil (W/O) emulsifier.

19. A method according to claim 18, wherein the HLB (Hydrophile-Lipophile-Balance) of said W/O emulsifier is below 9.

20. A method according to claim 19, wherein HLB is in the range of 3-7.

21. A method according to claim 16, wherein said emulsifier is a polymeric surfactant.

22. A method according to claims 16, wherein said emulsifier is selected from the group consisting of mono-or diglycerides, sorbitan fatty acid esters, polyoxyethylene sorbitol ester and polyoxyethylene alcohols

23. A composition for use in a method according to claim 1.

24. A crude oil mixture provided with a composition according to claim 23.

25. A steel pipeline system including at least one pipeline containing a crude oil mixture according to claim 24.

26. A method for transporting and/or storing a crude oil mixture according to claim 24, including the steps of adding a composition as claimed in claim 23 to a crude oil mixture, and supplying said crude oil mixture to transport means and/or storage means having an oil contacting surface which at least partly is a surface of a corrosion sensitive material.

27. A method for removing a composition from a crude oil mixture according to claim 24, said method including gravitating or sedimenting a composition as claimed in claim 25 from said crude oil mixture.

28. A method for inhibiting corrosion of a corrosion sensitive surface in contact with a corrosive water-containing crude oil mixture, comprising providing said crude oil mixture with a composition as claimed in claim 23 in an amount effective for the purpose of corrosion inhibition.

29. Use of a composition according to claim 23 to decrease the corrosivity of a water-containing corrosive crude oil mixture.

30. Use of a method according to claim 1 to decrease the corrosivity of a water-containing corrosive crude oil.
